(19) United States
(12) Patent Application Publication
(10) Pub. No.: US 2025/0028376 A1
(43) Pub. Date: Jan. 23, 2025

(54) MANUFACTURER USAGE DESCRIPTION (MUD) WIRELESS EMISSION POWER PROFILE EXTENSION

(71) Applicant: Cisco Technology, Inc., San Jose, CA (US)

(72) Inventors: Amine Choukir, Lausanne (CH); Pascal Thubert, Roquefort les Pins (CH); Domenico Ficara, Essertines-sur-Yverdon (CH); Eliot Lear, Wetzikon (CH)

(21) Appl. No.: 18/356,473

(22) Filed: Jul. 21, 2023

(51) Int. Cl. G06F 1/28

(52) U.S. Cl. CPC G06F 1/28

(57) ABSTRACT

Methods and systems are described herein for detecting deviations from an expected power profile of a device. The method comprises: retrieving a manufacturer usage description (MUD) associated with the device. The MUD includes a power profile associated with the device. An expected power consumption parameter can be determined from the power profile. The method may further comprise monitoring an actual power consumption parameter of the device and comparing the expected power consumption parameter to the actual power consumption parameter. The method may further comprise determining a deviation between the power consumption parameter and the expected power consumption indicated in the power profile, and outputting a notification when the deviation is equal to or greater than a threshold value.

### BACKGROUND

The number of unmanaged Internet-of-Things (IoT) devices connecting to a network has seen a significant increase in recent times (e.g., “smart home” technology, smart thermostats, smart refrigerators, WiFi-enabled lightbulbs, etc.). While the technology to secure managed devices, such as laptops, printers, tablets, and mobile phones, is fairly mature, this is not the case for other IoT devices, such as security cameras, smart home technology, or medical devices. This leaves a large gap in the security posture of many networks. A manufacturer usage description (MUD) is an embedded software standard that allows IoT device makers to advertise device specifications, including the intended communication patterns for their device when it connects to a network. The network can then use this intent to author a context-specific access policy, so the device functions only within those parameters.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example block diagram of a system for power profile and/or emissions profile monitoring in accordance with some embodiments of the present technology.

FIG. 2 illustrates an IoT system 200 in accordance with some embodiments.

FIG. 3 illustrates a routine 300 in accordance with some embodiments.

FIG. 4 illustrates a diagrammatic representation of an IoT device 400 in the form of a computer system within which a set of instructions may be executed for causing the machine to perform any one or more of the IoT functionalities discussed herein, according to some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Methods and systems are described herein for detecting deviations from an expected power profile of a device. The method comprises: retrieving a manufacturer usage description (MUD) associated with the device. The MUD includes a power profile associated with the device. An expected power consumption parameter can be determined from the power profile. The method may further comprise monitoring an actual power consumption parameter of the device and comparing the expected power consumption parameter to the actual power consumption parameter. The method may further comprise determining a deviation between the power consumption parameter and the expected power consumption indicated in the power profile, and outputting a notification when the deviation is equal to or greater than a threshold value.

The method may also include receiving a MUD associated with a device on a computer network, where the MUD is provided by a manufacturer of the device. In some examples, the method may also include generating correlation information associated with a type of device. The power consumption associated with the device may be correlated with a second power consumption associated with a second device, where the device and the second device are a same type of device. The method may also include reporting the correlation information and associated statistical behavior to a manufacturer of the type of device.

In some examples, monitoring the actual power consumption parameter includes monitoring a battery life of the device, and determining a deviation between the power consumption parameter and the expected power consumption indicated in the power profile includes determining a deviation between the battery life of the device over a duration of time and an expected battery life of the device indicated in the power profile. In some examples, the manufacturer usage description (MUD) associated with the device includes an RF profile. The method may also include monitoring a frequency output of the device, and determining a deviation between the frequency output of the device over a duration of time and an expected frequency output of the device indicated in the RF profile. The method may also include monitoring a communication pattern of the device, and determining a deviation between the communication pattern of the device over a duration of time and an expected communication pattern of the device indicated in the RF profile. The method may also include monitoring a transmit power of the device, determining a deviation between the transmit power of the device and an expected frequency output of the device indicated in the RF profile. Other technical features may be readily apparent to one skilled in the art from the following figures, descriptions, and claims.

The computer-implemented method may also include remediating the deviation in device operation relative to the power consumption profile. The remediating may include power cycling the device. The remediating may also include eliminating a power supply associated with the device, thereby powering off the device, when the deviation is equal to or greater than the threshold value.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for a streamlined method of monitoring power emissions, consumption, frequency outputs, etc. The number of unmanaged Internet-of-Things (IoT) devices connecting to a network has seen a significant increase in recent times (e.g., “smart home” technology, smart thermostats, smart refrigerators, WiFi-enabled lightbulbs, etc.). While the technology to secure managed devices, such as laptops, printers, tablets, and mobile phones, is fairly mature, this is not the case for other IoT devices, such as security cameras, smart home technology, or medical devices. An increasing number of IoT devices are based on a standard software stack, exposing them to Common Vulnerabilities and Exposures (CVE) which make them vectors for attacks wherever deployed. This leaves a large gap in the security posture of many networks. IoT devices are seldom updated, if even possible, which makes the attack vector even worse as an attacker can exploit any vulnerability discovered since the released version or last update of the IoT device software stack.

A solution to this is to utilize Manufacturer Usage Descriptions (MUD) to address these deficiencies at the network flow level by allowing the surrounding network, where the IoT device is deployed, to understand expected communication patterns and enforce them to reduce or even alleviate attack vectors on the device. A MUD is an embedded software standard that allows IoT device makers to advertise device specifications, including the intended communication patterns for their device when it connects to a network. The network can then use this information to author a context-specific access policy, so the device functions only within those parameters. In this manner, MUD becomes the authoritative identifier for expected performance for IOT devices on the network based on which policies can be created and deployed. MUD is a great improvement on security, and also on the monitoring of a deviation to a stated manufacturer network communication profile. Network communication patterns are just one of the dimensions that express the proper operation of an IoT device. Another notable dimension is an IoT device's power profile.

The present technology disclosed herein expresses the intended power profile and/or emissions profile of an IoT device of the manufacturer as part of the MUD descriptor so that the supporting network infrastructure can monitor any deviation. IOT devices mostly communicate wirelessly with a surrounding network and, therefore, have an emission profile that can be observed by the supporting network infrastructure. The emissions profile follows a communication pattern and is based on a designed power budget by the manufacturer. The designed power budget is established at manufacturing depending on the power source to enable the proper operation of the IOT device. The power profile may describe a type of power source the IOT device can ingest, an estimated energy level ingested, battery life (e.g., discharge and recharge history), etc. A deviation from the intended power profile and/or emissions profile may be the consequence of an attacker using the device as a vector of attack on the network, a software stack bug on the device, and/or firmware or hardware malfunction. The detection of the aforementioned events ensures higher network security and optimized IoT device function. The MUD power profile monitoring is also correlated across IoT devices of the same type to compensate for emission statistical behavior. Additionally, the correlation and statistical behavior may also be reported to manufacturers for quality assessment and additional services.

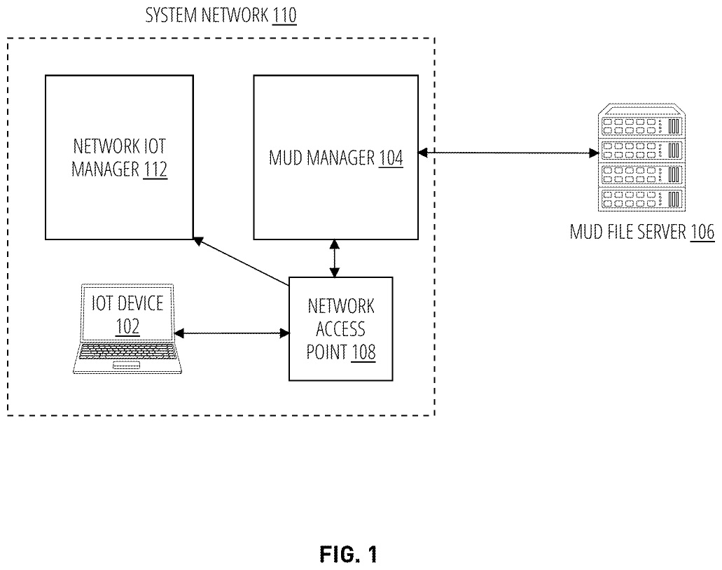

FIG. 1 illustrates an example block diagram of a system for power profile and/or emissions profile monitoring in accordance with some embodiments of the present technology. System network 110 may be a wide area wireless network associated with an enterprise, building, home, etc. The system network 110 may have one or more Internet-of-Things (IOT) devices connected, including IOT device 102. IOT device 102 may be a laptop, desktop, smartphone, smart thermostat, smart lightbulb, refrigerator, or any other device that may connect to the Internet. System network 110 may also comprise manufacturer usage description (MUD) manager 104. MUD manager 104 may be configured to process communications between MUD file server 106 and the network (e.g., network access point 108, IOT device 102, system network 110, network IOT manager 112, etc.). MUD manager 104 may be equipped with one or more elements (e.g., processors, servers, controllers, etc.) necessary to facilitate the communications.

In an example embodiment, IOT device 102 may connect to system network 110 via network access point 108. Upon connection, IOT device 102 may send a MUD uniform resource locator (URL) embedded in a request (e.g., an LLDP, DHCP, 802.1X, etc.) to MUD manager 104 via network access point 108. In some examples, MUD manager 104 may transmit the MUD URL to MUD file server 106. MUD file server 106 may, in response to the transmission from MUD manager 104, may transmit a MUD profile and signature to MUD manager 104. MUD manager 104 may retrieve the MUD profile and signature and validate the signature. The MUD profile may contain device specifications associated with IOT device 102, including, but not limited to, the intended communication patterns for IOT device 102 (e.g., specifying either specific hosts for cloud-based services or certain classes for access within an operational network). In some examples, MUD manager 104 may query the administrator for permission to add IOT device 102 and an associated policy. The MUD profile may include communication data for IOT device 102. MUD manager 104 may translate the communication data into one or more network access policies applicable to system network 110 and may instantiate a local configuration for IOT device 102. The one or more network access policies may be transmitted to network access point 108, which is configured by MUD manager 104 to enforce the one or more network access policies, which permits or denies access of IOT device 102 to system network 110. When IOT device 102 disconnects from the network, the one or more network access policies are removed.

In some examples, the MUD profile may include a power profile. The power profile may include one or more expected power consumption parameters. The one or more expected power consumption parameters may describe the expected power consumption, activity, phases, cycle, patterns, any combination thereof, or the like, associated with IOT device 102. For example, the power profile may include an expected battery life for IOT device 102. In some other examples, the MUD profile may include an emissions profile. The emissions profile may include one or more expected emissions parameters that may describe an expected communication pattern, a frequency output, a transmit power, any combination thereof, or the like, associated with IOT device 102. For example, the emissions profile may include an anticipated communication pattern for the IOT device 102.

In some examples, the MUD profile may be stored in network IOT manager 112. Network IOT manager 112 may be a system of one or more elements (e.g., processors, controllers, servers, etc.) configured to monitor one or more IOT devices (e.g., IOT device 102). In some examples, network IOT manager 112 is within system network 110. Network access point 108 may transmit the MUD profile to network IOT manager 112 and network IOT manager 112 may learn the one or more expected power consumption parameters and/or the one or more expected emissions parameters associated with IOT device 102.

Over the duration of the connection of IOT device 102 to system network 110, network access point 108 may monitor one or more power consumption parameters associated with IOT device 102. In some examples, network access point 108 may monitor one or more emissions parameters associated with IOT device 102. The one or more power consumption parameters and/or emissions parameters may correspond to the one or more expected power consumption parameters and/or the one or more expected emissions parameters, respectively. For example, if the power profile includes the expected battery life for IOT device 102, a power consumption parameter may be the battery life of IOT device 102 over a duration of time. As another example, if the emissions profile includes an expected communication pattern for IOT device 102, an emissions parameter may be the number of communications from IOT device 102 over a duration of time.

Network access point 108 may monitor the one or more power consumption parameters and/or emissions parameters and transmit data gathered to network IOT manager 112. The data may be transmitted in real-time, periodically, or at a particular event (e.g., the IOT device 102 completely depletes the battery). The data transmitted from network access point 108 may vary according to the power consumption parameter and/or emissions parameter. For example, network access point 108 may monitor a duration of time it takes for a battery to deplete, a number of communications over a duration of time, a communication pattern over a duration of time, a power output over a duration of time, how much power is requested from a power supply controller, heat generated based on internal device resistance, a frequency of an output from IOT device 102, any combination thereof, or the like. Network access point 108 may be equipped with one or more sensors capable of gathering data of this type (e.g., current sensors, frequency receivers, etc.).

Network IOT manager 112, upon receipt of data pertaining to a power consumption parameter of the one or more power consumption parameters, may generate comparable data using the relevant expected power consumption parameter received from the power profile. In some examples, network IOT manager 112, upon receipt of data pertaining to an emissions parameter of the one or more emissions parameters, may generate comparable data using the relevant expected emissions parameters received from the emissions profile. Network IOT manager 112 may gather data related to the power consumption parameter and/or emissions parameter and may modify the gathered data in a non-substantive manner to generate an appropriate comparison for the power consumption parameter and/or emissions parameter (e.g., data is from the same time frame, a similar communication, similar demands, etc.). Network IOT manager 112 may compare the power consumption parameter and the comparable expected power consumption parameter and determine a deviation between the two values. A similar process may be completed for the emissions parameter and the comparable expected emissions parameter. For example, if the battery in IOT device 102 depletes in 8 hours, but the battery was expected to deplete in 10 hours, the deviation would be 2 hours.

Network IOT manager 112 may notify an administrator of system network 110, system network 110 (e.g., network controller, etc.), network access point 108, any combination thereof, or the like, if the deviation between the expected power consumption parameter and the power consumption parameter exceeds a threshold value. In some examples, a notification may also be sent if the deviation between the expected emissions parameter and the emissions parameter exceeds a threshold value. The threshold value may be a default value, may be set by the administrator of system network 110, may be a recommended threshold value contained within the power profile and/or emissions profile of IOT device 102, any combination thereof, or the like. The notification may comprise an alert on a user interface, an email, a text message, an audio signal, a notification on a mobile application, any combination thereof, or the like.

In some examples, network IOT manager 112 may correlate the power consumption parameter associated with IOT device 102 with the power consumption parameter associated with a second IOT device. Network IOT manager 112 may also correlate the emissions parameter associated with IOT device 102 with the emissions parameter associated with the second IOT device. IOT device 102 and the second IOT device may be the same variety of device, produced by the same manufacturer, any combination thereof, or the like. The correlation may be performed to reduce and/or compensate for erratic statistical behavior. In some examples, statistics may be generated by network IOT manager 112 that may contain data from one or more IOT devices with one or more similarities (e.g., same type of device, same manufacturer, similar power profiles, etc.). The statistics may be generated by one or more algorithms within network IOT manager 112. In some examples, the correlation data generated by comparing IOT device 102, the second IOT device, and any other similar devices, may also be utilized to generate data describing the power emissions, power consumption, frequency emissions, any combination thereof, or the like, of one or more IOT devices. In some examples, the statistical and/or correlation data may be transmitted to one or more relevant manufacturers. For example, if the one or more IOT devices are of a similar variety and are manufactured by the same manufacturer, the system network 110 (e.g., network IOT manager 112) may transmit the data to the manufacturer for quality control, internal documentation, additional testing, etc. The statistical and/or correlation data may be sent in response to a request from a manufacturer. In some examples, the statistical and/or correlation data may be automatically sent periodically (e.g., every week, every month, every day, etc.).

In some examples, system network 110 may remediate the deviation in IOT device 102 if a deviation of a threshold value is detected within system network 110. In some examples, this may include power cycling IOT device 102. In some other examples, this may include eliminating a power supply associated with the device, which would “power off” IOT device 102. Remediating the deviation may reduce the risk of a security threat gaining access to one or more additional IOT devices associated with system network 110. In some examples, system network 110 may report the deviation to a manufacturer of IOT device 102. The report may contain one or more elements of data, including the expected power consumption parameter and/or expected emissions parameter, power consumption parameter, emissions parameter, emissions profile, power profile, contents of the MUD profile associated with IOT device 102, data received by network access point 108 and/or network IOT manager 112, any combination thereof, or the like.

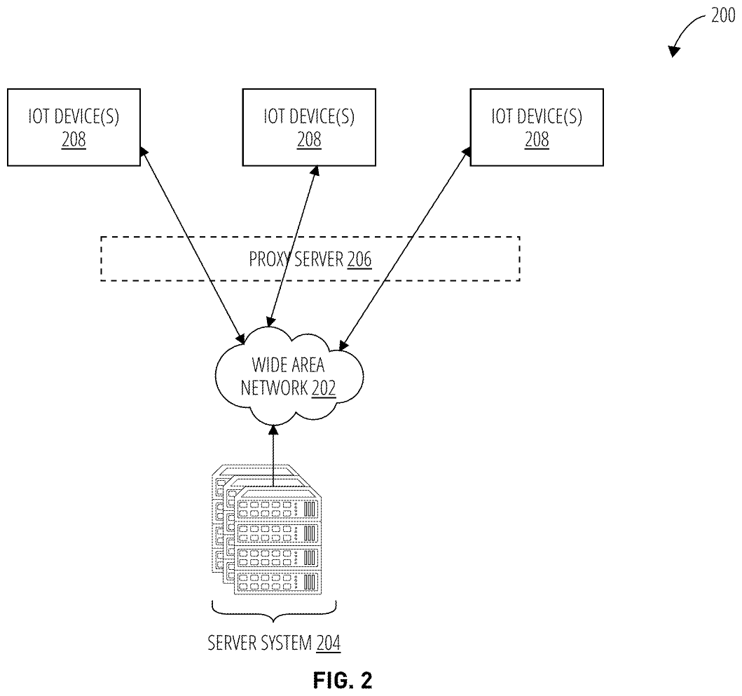

FIG. 2 illustrates an IoT system 200 in some embodiments. The IoT system 200 comprises IoT device(s) 208 communicatively coupled via a wide area network 202 to a server system 204 via an optional proxy server 206. While FIG. 2 illustrates a hub-and-spoke network topology of the IoT system 200 other topologies such as a hybrid hub-and-spoke, a mesh-network, a partially connected mesh-network topology are also common. Some networks can utilize a variety of these common network topologies wherein one branch of the network may use one network topology, while another branch of the network might use another network topology.

In a hub-and-spoke network topology of the IOT system 200, the IOT device(s) 208 has a 1:1 communication channel to the server system 204 and the IOT device(s) 208 communicates with the others, if at all, via the server system 204.

In a hybrid hub-and-spoke network topology of the IOT system 200, one or more of the network access points 108 acts as a gateway device providing a communication channel to the server system 204. The IOT device(s) 208 that are not the gateway device communicate directly with the IOT device(s) 208, or via the proxy server 206, which communicates on their behalf and on its own behalf with the server system 204.

In a mesh network topology of the IOT system 200, the IOT device(s) 208 are organized into groups of fully connected meshes, and communicate within a mesh group without interacting with the server system 204 or proxy server 206. In other embodiments, there may be one fully connected mesh of the IOT device(s) 208, although this requires that each of the IOT device(s) 208 is in direct communication range of all of the others. One or more of the IOT device(s) 208 acts as a gateway device providing a communication channel to the server system 204. The IOT device(s) 208 that are not the gateway device communicate directly with the gateway device, or via the proxy server 206, which communicates on their behalf and on its own behalf with the server system 204.

In a partially connected mesh network topology of the IOT system 200, the IOT device(s) 208 are organized into groups of partially connected meshes, and communicate within a mesh group without interacting with the server system 204 or proxy server 206. This type of network topology may be found in environments in which the IOT device(s) 208 are spread apart and battery powered, so that they can only communicate using relatively short-range wireless communications (e.g., near-field communications). In such environments a particular one of the IOT device(s) 208 may only be within communication range of a nearest neighbor. One or more of the IOT device(s) 208 acts as a gateway device providing a communication channel to the server system 204. The IOT device(s) 208 that are not the gateway device communicate directly with the gateway device, or via the proxy server 206, which communicates on their behalf and on its own behalf with the server system 204.

The optional proxy server 206 may improve the performance of the IOT system 200 by mirroring some or all of the state of the server system 204 and thus enabling the IOT device(s) 208 to communicate without creating bandwidth or incurring the latency of the wide area network 202. The optional proxy server 206 is typically colocated at a facility or nearby facility to where the IOT device(s) 208 are located.

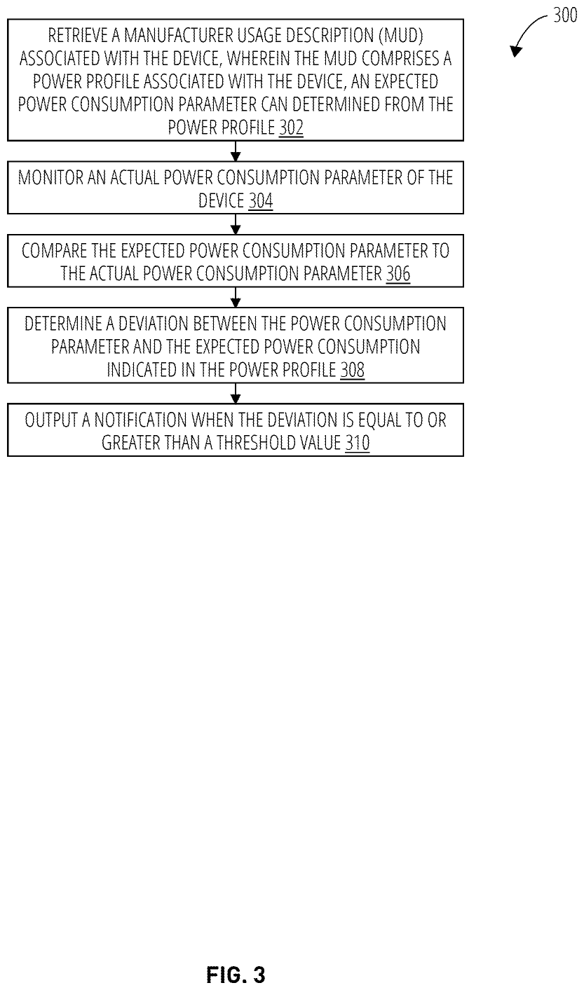

FIG. 3 illustrates an example routine 300 for detecting deviations from an expected power profile of a device. Although the example routine 300 depicts a particular sequence of operations, the sequence may be altered without departing from the scope of the present disclosure. For example, some of the operations depicted may be performed in parallel or in a different sequence that does not materially affect the function of the routine 300. In other examples, different components of an example device or system that implements the routine 300 may perform functions at substantially the same time or in a specific sequence.

A solution to some of the problems identified above is to utilize Manufacturer Usage Descriptions (MUD) to address these deficiencies. MUD becomes the authoritative identifier for expected performance for IOT devices on the network based on which policies can be created and deployed. MUD is a great improvement on security, and also on the monitoring of a deviation to a stated manufacturer network communication profile. Network communication patterns are just one of the dimensions that express the proper operation of an IOT device. Another notable dimension is an IOT device's power profile and/or emissions profile.

According to some examples, the method includes retrieving a MUD associated with the device, wherein the MUD comprises a power profile associated with the device, an expected power consumption parameter can be determined from the power profile at block 302. For example, the MUD manager 104 may receive the MUD from the MUD file server 106. The MUD may include the power profile containing one or more power consumption parameters. In some examples, in lieu of the power profile or in addition to the power profile, the MUD may include an emissions profile containing one or more emissions parameters. For example, the power profile and/or emissions profile may include an expected battery life, an expected power consumption, a frequency output, a transmit power, an expected communication pattern, an expected amount of heat generated based on internal device resistance, any combination thereof, or the like. The MUD may be associated with an Internet-of-Things (IOT) device connected to a network (e.g., system network 110 described in FIG. 1). In some examples, the MUD is provided by a manufacturer of the IoT device (e.g., IOT device 102 described in FIG. 1) and stored in a MUD file server for retrieval.

A MUD manager may facilitate the retrieval and storage of the MUD, including, but not limited to, transmitting a MUD URL to the MUD file server, receiving the MUD from the MUD file server, validating a digital signature of the MUD file, querying an administrator for permission to add the IOT device to the network, translating the MUD into one or more access policies, instantiate a local configuration for the IOT device, transmitting the one or more access policies to a network access point (e.g., network access point 108 described in FIG. 1), configuring the network access point, any combination thereof, or the like. In some examples, the MUD manager may transmit the MUD to a network IOT manager (e.g., network IOT manager 112 described in FIG. 1) to store and/or learn the one or more power consumption parameters and/or Emissions parameters.

According to some examples, the method includes monitoring an actual power consumption parameter of the device at block 304. For example, network access point 108 may monitor one or more actual power consumption parameters associated with IOT device 102. In some examples, a network access point may monitor an actual emissions parameter associated with the device. The network access point may comprise one or more sensors (e.g., current sensor, heat sensor, etc.) necessary to collect data pertaining to the one or more power consumption parameters and/or emissions parameters within the MUD. In some examples, the network access point may be monitoring more than one IOT device. The network access point may monitor a duration of time it takes for a battery to deplete, a number of communications over a duration of time, a communication pattern over a duration of time, a power output over a duration of time, how much power is requested from a power supply controller, heat generated based on internal device resistance, a frequency of an output from IOT device, any combination thereof, or the like. The network access point may transmit data associated with the one or more actual power consumption parameters and/or the one or more actual emissions parameters to the network IOT manager. The network access point may transmit this data in real-time, on-demand, periodically, any combination thereof, or the like, to the network IOT manager. The network IOT manager may store the data in a location accessible to the network IOT manager and may input the data into one or more algorithms to generate usable graphs, information, data, trends, statistics, etc.

According to some examples, the method includes comparing the expected power consumption parameter to the actual power consumption parameter at block 306. For example, network IOT manager 112 may compare an expected power consumption parameter (e.g., battery life) from the MUD to an actual power consumption parameter (e.g., actual battery life) received from network access point 108. The network IOT manager may also compare an expected emissions parameter from the MUD to an actual emissions parameter received by the network access point. In some examples, the network IOT manager may receive data associated with the IOT device and a second IOT device of a similar type (e.g., same manufacturer, same type of device, any combination thereof, or the like). The network IOT manager may correlate the data from more than one IOT device and generate correlation information associated with a type of device. Correlating the received data may ensure that erroneous and/or erratic data may be mitigated. Additionally, the correlation information may include statistical analysis of the type of device. In some examples, the correlation information and/or the statistical analysis of the type of device may be reported to the manufacturer of the type of device. The reporting may occur periodically, on-demand, after a certain threshold has been met (e.g., three power cycles, an event, etc.), etc.

According to some examples, the method includes determining a deviation between the power consumption parameter and the expected power consumption indicated in the power profile at block 308. For example, the network IOT manager 112 may determine a deviation between the actual power consumption parameter and an associated power consumption parameter identified in the MUD for IOT device 102. In some examples, the network IOT manager may determine a deviation between the actual emissions parameter and an associated emissions parameter identified in the MUD associated with the device. For example, if the power consumption parameter identified in the MUD is an expected battery life of 6 hours, and the actual battery life is 2 hours, then the deviation would be 4 hours. In some examples, the deviation may be a value, a standard deviation, a correlation, an integral/derivative, another type of mathematical calculation, any combination thereof, or the like.

In some examples, the network IOT manager may determine a deviation between the frequency output of the device over a duration of time and an expected frequency output of the device indicated in the emissions profile. As another example, the network IOT manager may determine a deviation between the communication pattern of the device over a duration of time and an expected communication pattern of the device indicated in the emissions profile. As yet another example, the network IOT manager may determine a deviation between the transmit power of the device and an expected frequency output of the device indicated in the emissions profile.

According to some examples, the method includes outputting a notification when the deviation is equal to or greater than a threshold value at block 310. For example, the network IOT manager 112 may generate and output a notification to an administrator of the system network 110 regarding the IOT device 102. The notification may be a notification on a user interface associated with the network, a smartphone notification, an email, a text message, any combination thereof, or the like. The notification may be received by the administrator of the system, a group of individuals managing the system, a third-party (e.g., outside the enterprise associated with the network), any combination thereof, or the like. The notification may include the relevant device, the amount of deviation, the possible cause of the deviation, any remediation being applied to the relevant device, other devices that may be impacted by the relevant device (e.g., impacted by the root cause of the deviation and/or impacted by the remediation), any combination thereof, or the like.

In some examples, the threshold value may be set by the administrator of the network. In some other examples, the threshold value may be included in the power profile and/or the emissions profile associated with the device and/or otherwise provided by the manufacturer. For example, the manufacturer may include within the power profile for a device an expected tolerance for various parameters within the power profile. As another example, the manufacturer may include within the emissions profile for the device an expected frequency range of communication signals. In some other examples, the threshold value may be set by one or more security policies implemented throughout the network. For example, if network security is a high priority, one or more security policies may set a “smaller” or “lower” threshold value (e.g., indicating less of a deviation), thereby catching potential security threats faster.

In some examples, the network and/or the network IOT manager 112 may remediate the deviation in device operation relative to the power profile. The remediation may be implemented to mitigate potential impact to the remainder of the network. The remediation may include power cycling the device, eliminating a power supply associated with the device, shutting off communications to/from the device, any combination thereof, or the like.

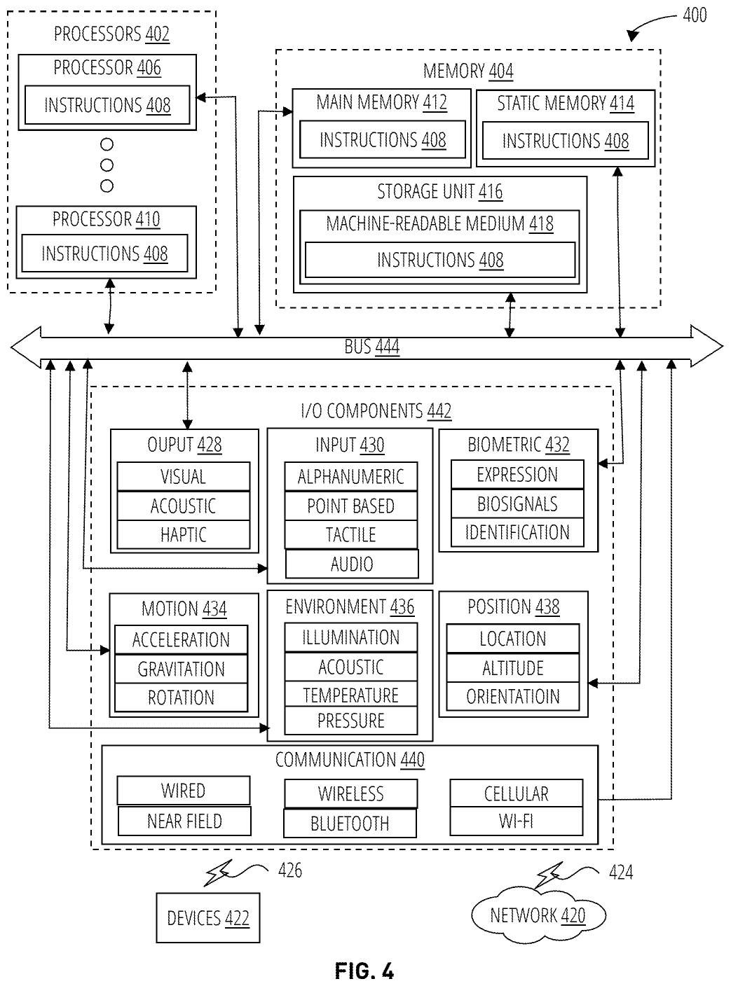

FIG. 4 illustrates a diagrammatic representation of an IoT device 400 in the form of a computer system within which a set of instructions may be executed for causing the IoT device 400 to perform any one or more of the methodologies discussed herein, according to an example embodiment. Specifically, FIG. 4 shows a diagrammatic representation of the IoT device 400 in the example form of a computer system, within which instructions 408 (e.g., software, a program, an application, an applet, an app, or other executable code) for causing the IoT device 400 to perform any one or more of the methodologies discussed herein may be executed.

The instructions 408 transform the general, non-programmed IoT device 400 into a particular IoT device 400 programmed to carry out the described and illustrated functions in the manner described. In alternative embodiments, the IoT device 400 operates as a standalone device or may be coupled (e.g., networked) to other machines. In a networked deployment, the IoT device 400 may operate in the capacity of a server machine or a client machine in a server-client network environment, or as a peer machine in a peer-to-peer (or distributed) network environment. The IoT device 400 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), a security camera, other smart devices, a web appliance, a network router, a network switch, a network bridge, or any machine capable of executing the instructions 408, sequentially or otherwise, that specify actions to be taken by the IoT device 400.

Further, while only a single IoT device 400 is illustrated, the term “machine” shall also be taken to include a collection of machines that individually or jointly execute the instructions 408 to perform any one or more of the methodologies discussed herein.

The IoT device 400 may include processors 402, memory 404, and I/O components 442, which may be configured to communicate with each other such as via a bus 444. In an example embodiment, the processors 402 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 406 and a processor 410 that may execute the instructions 408. The term “processor” is intended to include multi-core processors that may comprise two or more independent processors (sometimes referred to as “cores”) that may execute instructions contemporaneously. Although FIG. 4 shows multiple processors 402, the IoT device 400 may include a single processor with a single core, a single processor with multiple cores (e.g., a multi-core processor), multiple processors with a single core, multiple processors with multiples cores, or any combination thereof.

The memory 404 may include a main memory 412, a static memory 414, and a storage unit 416, both accessible to the processors 402 such as via the bus 444. The main memory 404, the static memory 414, and storage unit 416 store the instructions 408 embodying any one or more of the methodologies or functions described herein. The instructions 408 may also reside, completely or partially, within the main memory 412, within the static memory 414, within machine-readable medium 418 within the storage unit 416, within at least one of the processors 402 (e.g., within the processor's cache memory), or any suitable combination thereof, during execution thereof by the IoT device 400.

The I/O components 442 may include a wide variety of components to receive input, provide output, produce output, transmit information, exchange information, capture measurements, and so on. The specific I/O components 442 that are included in a particular machine will depend on the type of machine. For example, portable machines such as mobile phones will likely include a touch input device or other such input mechanisms, while a headless server machine will likely not include such a touch input device. It will be appreciated that the I/O components 442 may include many other components that are not shown in FIG. 4. The I/O components 442 are grouped according to functionality merely for simplifying the following discussion and the grouping is in no way limiting. In various example embodiments, the I/O components 442 may include output components 428 and input components 430. The output components 428 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 430 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 442 may include biometric components 432, motion components 434, environmental components 436, or position components 438, among a wide array of other components. For example, the biometric components 432 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environmental components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 438 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 442 may include communication components 440 operable to couple the IoT device 400 to a network 420 or devices 422 via a coupling 424 and a coupling 426, respectively. For example, the communication components 440 may include a network interface component or another suitable device to interface with the network 420. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 422 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geolocation, location via Wi-Fi® signal triangulation, location via detecting an NFC beacon signal that may indicate a particular location, and so forth.

The various memories (i.e., memory 404, main memory 412, static memory 414, and/or memory of the processors 402) and/or storage unit 416 may store one or more sets of instructions and data structures (e.g., software) embodying or utilized by any one or more of the methodologies or functions described herein. These instructions (e.g., the instructions 408), when executed by processors 402, cause various operations to implement the disclosed embodiments.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain embodiments within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method of detecting deviations from an expected power profile of a device, comprising:
retrieving a manufacturer usage description (MUD) associated with the device, wherein the MUD comprises a power profile associated with the device, an expected power consumption parameter can determined from the power profile;
monitoring an actual power consumption parameter of the device;
comparing the expected power consumption parameter to the actual power consumption parameter;
determining a deviation between the actual power consumption parameter and the expected power consumption parameter indicated in the power profile; and
outputting a notification when the deviation is equal to or greater than a threshold value.

2. The computer-implemented method of claim 1, further comprising generating correlation information associated with a type of device.

3. The computer-implemented method of claim 2, further comprising:
correlating the actual power consumption parameter associated with the device with a second actual power consumption parameter associated with a second device, wherein the device and the second device are the type of device.

4. The computer-implemented method of claim 2, further comprising:
reporting the correlation information and associated statistical behavior to a manufacturer of the type of device.

5. The computer-implemented method of claim 1, further comprising:
remediating the deviation in device operation relative to the power profile.

6. The computer-implemented method of claim 5, wherein the remediating includes:
power cycling the device.

7. The computer-implemented method of claim 5, wherein the remediating includes:
eliminating a power supply associated with the device, thereby powering off the device, when the deviation is equal to or greater than the threshold value.

8. The computer-implemented method of claim 1,
wherein the monitoring the actual power consumption parameter includes monitoring a battery life of the device; and
wherein the determining a deviation between the actual power consumption parameter and the expected power consumption parameter indicated in the power profile includes determining a deviation between the battery life of the device over a duration of time and an expected battery life of the device indicated in the power profile.

9. The computer-implemented method of claim 1, wherein the manufacturer usage description (MUD) associated with the device includes an emissions profile.

10. The computer-implemented method of claim 9, further comprising:
monitoring a frequency output of the device; and
determining a deviation between the frequency output of the device over a duration of time and an expected frequency output of the device indicated in the emissions profile.

11. The computer-implemented method of claim 9, further comprising:
monitoring a communication pattern of the device; and
determining a deviation between the communication pattern of the device over a duration of time and an expected communication pattern of the device indicated in the emissions profile.

12. The computer-implemented method of claim 9, further comprising:
monitoring a transmit power of the device; and
determining a deviation between the transmit power of the device and an expected frequency output of the device indicated in the emissions profile.

13. The computer-implemented method of claim 1, further comprising:
receiving a MUD associated with a device on a computer network, wherein the MUD is provided by a manufacturer of the device.

14. A computing apparatus comprising:
a processor; and
a memory storing instructions that, when executed by the processor, configure the apparatus to:
retrieve a manufacturer usage description (MUD) associated with a device, wherein the MUD comprises a power profile associated with the device, an expected power consumption parameter can determined from the power profile;
monitor an actual power consumption parameter of the device;
compare the expected power consumption parameter to the actual power consumption parameter;
determine a deviation between the actual power consumption parameter and the expected power consumption parameter indicated in the power profile; and
output a notification when the deviation is equal to or greater than a threshold value.

15. The computing apparatus of claim 14, wherein the instructions further configure the apparatus to:
generate correlation information associated with a type of device.

16. The computing apparatus of claim 15, wherein the instructions further configure the apparatus to:
correlate the actual power consumption parameter associated with the device with a second actual power consumption parameter associated with a second device, wherein the device and the second device are the type of device.

17. The computing apparatus of claim 15, wherein the instructions further configure the apparatus to:
report the correlation information and associated statistical behavior to a manufacturer of the type of device.

18. The computing apparatus of claim 14, wherein the instructions further configure the apparatus to:
remediate the deviation in device operation relative to the power profile.

19. The computing apparatus of claim 14, wherein the instructions further configure the apparatus to:
receive a MUD associated with a device on a computer network, wherein the MUD is provided by a manufacturer of the device.

20. A non-transitory computer-readable storage medium, the computer-readable storage medium including instructions that when executed by a computer, cause the computer to:
retrieve a manufacturer usage description (MUD) associated with a device, wherein the MUD comprises a power profile associated with the device, an expected power consumption parameter can determined from the power profile;
monitor an actual power consumption parameter of the device;
compare the expected power consumption parameter to the actual power consumption parameter;
determine a deviation between the actual power consumption parameter and the expected power consumption parameter indicated in the power profile; and
output a notification when the deviation is equal to or greater than a threshold value.
